(19) United States
(12) Patent Application Publication
(10) Pub. No.: US 2016/0080855 A1
(43) Pub. Date: Mar. 17, 2016

(54) Jewelry Having Electronic Modules

(71) Applicants: Russell Greenberg, New York, NY (US); Noosheen Hashemi, Menlo Park, CA (US); Minchul Hong, New York, NY (US); Michael Rosenblatt, Boulder, CO (US); Andrew Bert Hodge, Palo Alto, CA (US); Shervin Pishevar, San Francisco, CA (US)

(72) Inventors: Russell Greenberg, New York, NY (US); Noosheen Hashemi, Menlo Park, CA (US); Minchul Hong, New York, NY (US); Michael Rosenblatt, Boulder, CO (US); Andrew Bert Hodge, Palo Alto, CA (US); Shervin Pishevar, San Francisco, CA (US)

(73) Assignee: BEED, Inc., San Francisco, CA (US)

(21) Appl. No.: 14/952,465

(22) Filed: Nov. 25, 2015

Related U.S. Application Data
(60) Provisional application No. 62/084,840, filed on Nov. 26, 2014.
(60) Provisional application No. 62/202,432, filed on Aug. 7, 2015.

(51) Int. Cl. H04R 1/10; H04R 1/04; H04R 1/02

(52) U.S. Cl. CPC H04R 1/1066; H04R 1/1016; H04R 1/028; H04R 1/04; H04R 2201/023

(57) ABSTRACT

Disclosed is a deconstructed computer that operates as multifunctional headphones having an ornamental appearance. In one embodiment, the headphones include a plurality of modular beads that are connected by a wire in an open necklace configuration. The wire and the modular beads are distributed and shaped so that they can be comfortably draped and counter-balanced around a wearer's body, such as in the manner of jewelry. Additionally, the wire and the modular beads can be adjusted in multiple configurations without falling off or slipping into unwanted positions. Each of the modular beads include various types of input and output devices to communicate with one another and/or other external electronic devices paired thereto.

### CROSS-REFERENCE TO RELATED APPLICATIONS

This application claims the benefit of U.S. Provisional Patent Application Ser. No. 62/084,840, filed Nov. 26, 2014, and U.S. Provisional Patent Application Ser. No. 62/202,432, filed Aug. 7, 2015, which are hereby incorporated by reference in their entirety.

### FIELD OF THE INVENTION

The present invention generally relates to wireless headphones. More particularly, the present invention is directed to wireless headphones having a jewelry-like appearance, with a portion draped around a wearer's neck, and a variety of modular beads for facilitating the use thereof.

### BACKGROUND OF THE INVENTION

Various types of wireless headphones are known in the art. Traditional headphones generally comprise a pair of earphones or padded speaker mounts and a wireless receiver supported by a housing unit. Some headphones further comprise a microphone and a control unit for controlling the volume. In this regard, the headphones are generally controlled via an electronic device to which it is connected. As understood herein, a drawback of traditional wireless headphones is that the wearer must have his or her device accessible in order to further operate the headphones or the device. The present invention further understands that it would be desirable to address this problem so as to allow the wearer to control the headphones and the device without constantly having the device on hand or outside of a carrier for the device.

Additionally, traditional headphones are generally not attractive in appearance and lack aesthetic qualities. Thus, many individuals customize their headphones and utilize various types of ornamental decoration to increase the overall aesthetic quality of the same. In this regard, the invention described herein addresses this problem.

### SUMMARY OF THE INVENTION

In view of the disadvantages inherent in the known types of devices for wireless headphones now present in the prior art, the present invention provides improved wireless headphones that resembles jewelry and that comprises a variety of modular beads.

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as to prelude to the more detailed description that is disclosed later.

In a preferred embodiment, the present invention comprises a plurality of modular beads that are connected by a wire in a linear configuration. The beads and the wire are ornamental in appearance so as to resemble a piece of jewelry, such as a necklace. The beads are distributed such that the sizes, weights, and spacing between individual beads is comfortable for draping and counter-balancing each other around a wearer's body, preferably around the neck.

For instance, the beads are symmetrically distributed such that each terminal end of the wire comprises an ear bead and the substantial midpoint of the wire comprises a mother bead, wherein each of the ear beads and the mother bead comprises various types of input and output devices and related electrical components embedded therein. Additionally, the present invention is preferably dimensioned and configured so that it can wrap at least once around the wearer's neck or other body parts, and can be adjusted in multiple configurations without falling off or slipping into unwanted positions.

It is therefore an object of the present invention to provide headphones that comprises a jewelry-like appearance, and that resembles a necklace, a bracelet, a ring, an anklet, earrings, a brooch, a charm, and the like.

It is another object of the present invention to provide headphones that can be wrapped around the wearer and worn in multiple ways on the wearer's body.

It is still another object of the present invention to provide headphones that can be motion-operated and/or touch-operated.

It is still another object of the present invention to provide headphones that comprises weighted modular beads for counter-balancing the headphones around a wearer's body.

It is still another object of the present invention to provide headphones that comprises a wire that is sheathed in a chain that is engineered to mitigate the risk of crimping or breaking the wire due to excessive flexure while providing a non-slip exterior surface.

It is still another object of the present invention to provide headphones that comprises at least one modular bead that generates an output signal in the form of a tactile vibration and visible output.

A final object of the present invention to provide wireless headphones that may be readily fabricated from materials that permit relative economy and commensurate with durability.

In the light of the foregoing, these and other objects are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 depicts a schematic diagram of a linear configuration of the present invention with ear beads on ends, a mother bead in center, and a hot bead/microphone spaced therebetween.

FIG. 2 depicts a schematic diagram of a wrapped configuration of the present invention when it is worn in front to properly balance the beads and enable adjustment of the chain.

FIGS. 3A through 3E show various embodiments of the mother bead, wherein the mother bead is configured to be worn on the front of the wearer.

FIG. 3F shows a schematic diagram of another embodiment of the mother bead, wherein the mother bead is configured to be positioned on the back of the neck of the wearer.

FIGS. 4A through 4C show various embodiments of the ear beads of the present invention.

FIG. 4D shows a side view of another embodiment of the ear bead of the present invention having a gasket for facilitating fit.

FIGS. 5 and 6 depict another embodiment of the ear beads of the present invention having a groove that allows for the ear beads to mate and slide along the length of the wire.

FIG. 7 shows a perspective view of an exemplary embodiment of the mother bead having a recessed capacitance trigger.

FIG. 8 depicts an exemplary system block diagram a hot bead within a necklace, according to an embodiment.

FIG. 9 depicts an exemplary system block diagram of ear beads and a mother bead.

### DETAILED DESCRIPTION OF THE INVENTION

The present invention is directed towards wireless headphones having a jewelry-like appearance. For purposes of clarity, and not by way of limitation, illustrative views of the present headphones are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” or “at least one” unless specified otherwise or clear from context to be directed to a singular form. It is to be appreciated that determinations or inferences referenced throughout the subject specification can be practiced through the use of artificial intelligence techniques.

Additionally, terms “mother bead” and “pendant” are used interchangeably, unless the context clearly indicates otherwise. As used herein, terms “hot bead” and “friend bead” are used interchangeable, unless the context clearly indicates otherwise. Finally, as used here, terms “user” and “wearer” are used interchangeably, unless the context clearly indicates otherwise.

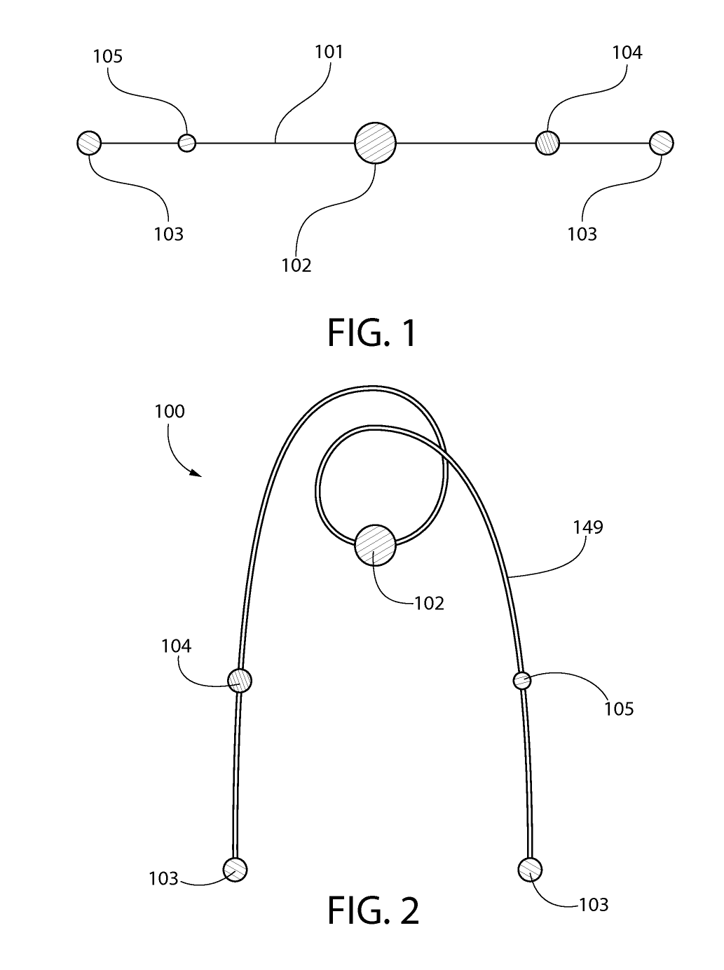

Referring now to FIG. 1, there is shown a schematic diagram of a linear embodiment of the present invention in a form of an open necklace. In the illustrated embodiment, the present invention comprises an elongated wire 101 having a plurality of modular beads 102, 103, 104, 105 thereon. Each of the modular beads 102, 103, 104, 105 preferably comprises a spherical housing member having a defined interior volume for storing electrical components therein. In this regard, the modular beads 102, 103, 104, 105 function similarly to a deconstructed computer. An outward appearance of each of the modular beads 102, 103, 104, 105 resembles an ornamental bead or at least a portion of an item of jewelry. In some embodiments, the spherical housing member comprises a first hemisphere and a second hemisphere, wherein the two hemispheres can removably mate via press fit or other suitable securing means to form a spherical shape when connected together.

In the illustrated embodiment, the housing member for each of the modular beads 102, 103, 104, 105 comprises two apertures diametrically opposed thereon, wherein the apertures are shaped and dimensioned to receive a portion of the wire 101 therethrough. When the wire 101 threads through the two apertures, the wire 101 can pass through the interior volume of the housing member and creates the illusion that the wire 101 is continuously threaded through each of the modular beads, which makes the beads feel more like jewelry than electrical components.

Alternatively, the housing member may comprise a closed loop that protrudes outward on an exterior thereof. The closed loop is configured to receive a portion of the wire 101 therethrough so that the modular beads can be strung onto the wire 101 individually, similar a loose charm. Although the modular beads 102, 103, 104, 105 have been described as being spherical beads, the modular beads may comprise different shapes and sizes, depending upon embodiment. Furthermore, the modular beads 102, 103, 104, 105 can be included in or coupled to a necklace as shown in FIG. 1, or coupled to other types of jewelry such as a bracelet, earrings, ring, brooch, pin, handbag, charm, belt, or other accessories.

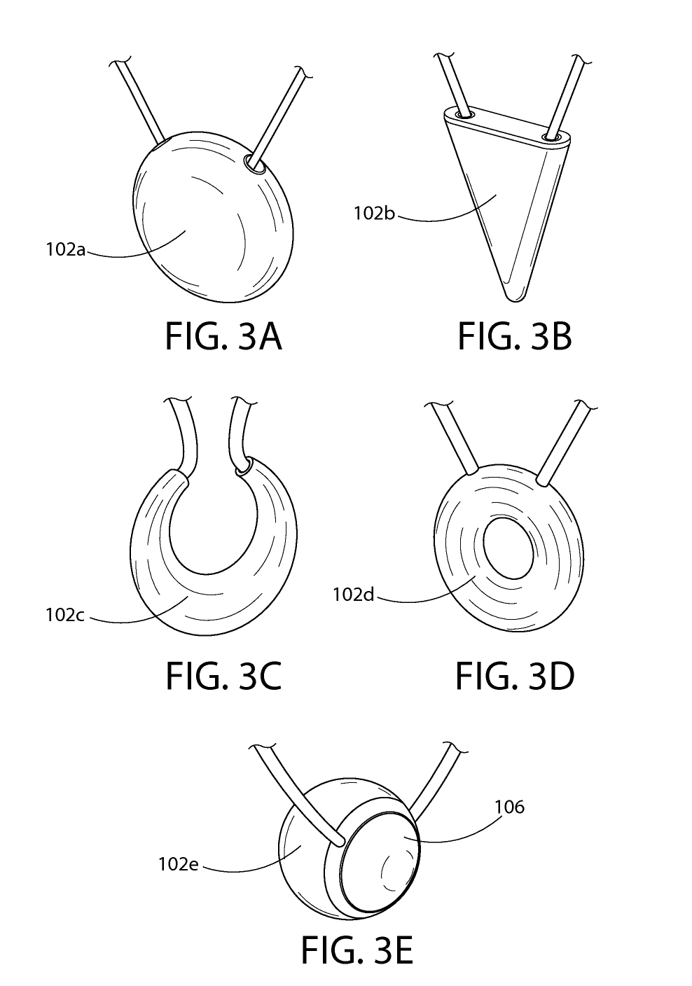

The wire 101 may comprise a single wire or a plurality of wires that connect together via the modular beads. The wire 101 is enclosed in wire sheathing 149 such as a chain or other types of sleeves that are composed of materials that are commonly used in jewelry, depicted in FIG. 2. Preferably, the wire sheathing is similar to a necklace chain so that it is aesthetically pleasing. In one embodiment, the wire sheathing comprises a high friction outer surface such that it does not slip or slide around easily when worn.

The wire 101 is flexible and can be manipulated and bent into different shapes. Similarly, the chain is hollow and flexible. There are no burred or sharp edges on the interior or exterior of the wire sheathing that might pierce the insulation on the wire 101. In one embodiment, the mesh of the chain is engineered to limit the turning radius of the wire 101, which mitigates the risk of crimping or breaking the wires due to excessive flexure. Such limited turning radius of the wire also reduces tangling. In this regard, the chain is designed in such a way so that it protects the wire, reduces tangling, and creates a weighted draping form that is ergonomic and visually attractive. Natural perforations between the linkages of the chain can allow regions for signals such as light and sound to penetrate, so that functionality can be embedded into the chain, either for input, e.g., microphone, or output, e.g., light emitting diode (LED) arrays.

The wire 101 comprises a first terminal end and a second terminal end, the first terminal end having a first ear bead 103 and the second terminal end having a second ear bead 103 connected thereto. The wire 101 further comprises a mother bead 102 at its substantial midpoint so that the mother bead 102 is centrally located to balance the weight of the modular beads on the wire 101. Additionally, the wire 101 is connected to a microphone 105, which is located between the first ear bead 103 and the mother bead 102, and a hot bead 104 that is located between the second ear bead 103 and the mother bead 102.

Each of ear beads 103 comprises a speaker so that the ear beads 103 primarily function as headphones, earbuds, or headsets. In some embodiments, the ear beads 103 comprise various components such as tactile sensors and output signal devices so that they can perform additional functions and act as hot beads 104 when the ear beads 103 are not worn in the ears. Moreover, the ear beads 103 may comprise a microphone embedded therein so as to eliminate the need for an external microphone 105 as depicted in the illustrated embodiment. In some embodiments, the present invention may further comprise a speaker bead in addition to the ear beads 103 for outputting audible sound when the ear beads 103 are not worn.

The mother bead 102 contains multiple components in one enclosure. In one embodiment, the mother bead 102 contains battery, haptic actuator, main printed circuit board (PCB), short-range wireless interconnection, e.g., Bluetooth®, charging surface, microphone, user interface (UI), e.g., buttons, and a variety of environmental sensors, e.g., accelerometer, thermometer, and global positioning system (GPS). The mother bead 102 generally operates as a master modular bead and communicates with other modular beads, i.e., slave modular beads, such as the ear beads 103 and the hot bead 104.

The hot bead 104 is an input and output module and thus acts as a direct line of communication. The hot bead 104 is dedicated to one or more specific functions. In one embodiment, the hot bead 104 is pre-programmed, i.e., before use by a consumer, for a predetermined function. In yet another embodiment, the hot bead 104 is programmable and/or is reprogrammable, i.e., by the user via a software application, for a second function different than a first function of the hot bead 104. Said another way, in some embodiments, the hot bead 104 can be dedicated to a first specified function at a first period of time, and a user (or other operator) can re-assign the hot bead 104 to a different functionality such that the hot bead 104 is dedicated to a second specified function at a second period of time after the first period of time.

The hot bead 104 can be dedicated to any suitable functionality, including, but not limited to, order placement, e.g., placing a food take-out or delivery order, remotely controlling an operation of a home security system, e.g., activating and deactivating an alarm system, turning on and off lights and/or appliances, opening and closing a garage door, accessing a home security video or audio feed, controlling the home's thermostat, monitoring the wearer's location and/or activity, or the like. In this regard, it is contemplated that the hot bead 104 can be in communication with a server and/or wirelessly paired with external electronic devices to operate the same. Accordingly, the hot bead 104 operates as a short cut to execute a specified functionality.

Additionally, the hot bead 104 can be used for communicating with another device, e.g., voice-to-voice, voice-to-text or other written messaging or vice versa, real-time two-way voice chat. When the hot bead 104 provides a real-time two-way voice chat, it acts as a radio transmitter similar to a “walkie talkie.” In this regard, the wearer may squeeze and hold the hot bead 104 to transmit voice communication or directly talk to another person. When the hot bead 104 is released, then the wearer can receive voice communication from the other person.

The hot bead 104 can output various types of signals such as vibrations or light when providing notifications. Accordingly, the hot bead 104 may comprise a haptic actuator and/or a LED. Additionally, the wire sheathing and/or the wire 101 can be strategically used to transmit haptic, i.e., vibration, to the surface of the skin of the wearer in order to alert the wearer of notifications. Preferably, the haptic actuator of the hot bead 104 and/or the mother bead 102 is strategically located in a proximal position to the wire 101 so as to transmit the vibration along the length of the wire 101. Even if the hot bead 104 and/or the mother bead 102 is worn outside a bulky winter jacket or over layers of clothing, therefore, the wearer would still be able to feel the vibration on the back of their neck. It is also contemplated that the present invention may be charged through the wire sheathing and/or use the wire sheathing as a capacitance or a received signal strength indication (RSSI) sensor.

The hot bead 104 can vibrate or emit light when a preselected person is calling. In one embodiment, the preselected person can be the user's emergency contact. In another embodiment, the hot bead 104 may be programmed to automatically select a person who falls under a certain category in the user's contact list, e.g., work or family. Alternatively, the user may manually designate a person within his or her contact list, and designate a different person at a later time.

Conversely, the hot bead 104 may be configured to call the preselected person directly when squeezed or otherwise actuated. When more than one person is designated as a preselected person, then the hot bead 104 may output different vibration or light patterns to distinguish each person. Similarly, the wearer can squeeze or otherwise actuate the hot bead 104 in different ways, e.g., a single squeeze, a double squeeze, to call different people.

Referring now to FIG. 2, there is shown a view of the present invention, as it would be worn as a necklace. Shape and details of the modular beads and the wire can change depending upon embodiment, but the weight and balance ratio with wire and ear beads is preferably within a desired range. The proximity of these beads is distributed and adjustable in a convenient one-size-fits-all manner to adapt to an infinite array of body types so as to allow for the most convenient and proximal relationship with the body parts most related.

For example, the ear beads 103 are located at the terminal ends of the wire to allow the wear to easily insert the beads into his or her ears. When the wearer has the ear beads 103 in his or her ears, he or she can easily adjust the length of the slack of wire falling from his or her ears by pulling on the mother bead 102. In addition, the wearer can adjust the assembly so that the mother bead 102 is closer to his or her mouth when the mother bead 102 is used as a microphone. In this way, the proximity of the mother bead 102 to the wearer's mouth makes for ideal hands-free communication. It also reduces the amount of white noise otherwise captured by the mother bead 102 when it is free-floating.

A concern when connecting any device to a wire, however, is the pull force that is necessary to disengage that wire connection. When the wire sheathing 149 is physically connected to the housing member of the modular beads, however, the wire itself is not pulled with such force that it would not disengage easily. Additionally, because the interior volume of some of the modular beads may be limited in space, the wire may be too crimped when extended through the modular beads as enclosed in the wire sheathing 149 in some embodiments. In such embodiments, the wire sheathing 149 may be connected to the exterior of the housing member of the ear beads 103 so that it does not extend through the interior volume of the ear buds 103.

The positioning of this wire along a line of radial symmetry on each modular bead means there is no obvious up or down orientation for the necklace embodiment. In some instances, however, a specific orientation of the beads may be desired, i.e., microphone facing up close to mouth as opposed to down away from mouth. In these cases, beads can be weighted to promote them falling in a position that properly orients features relative to the body. In some embodiments, the mother bead 102 or other beads such as the hot bead 104 is rotated by a wearer to access virtual libraries of information, menu options, or the like, or otherwise activate the functionality of the bead, and thus the substantially spherical shape of the bead also facilitates such rotational movement in operation by the wearer.

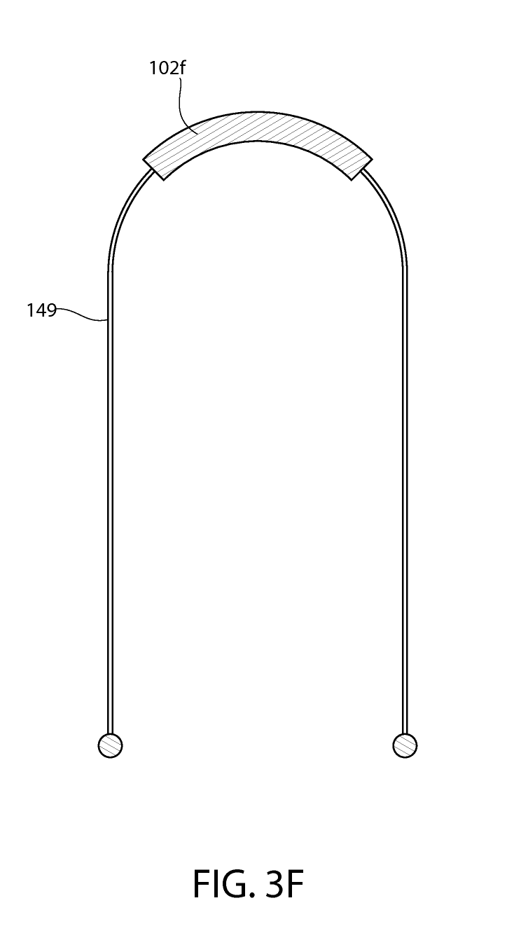

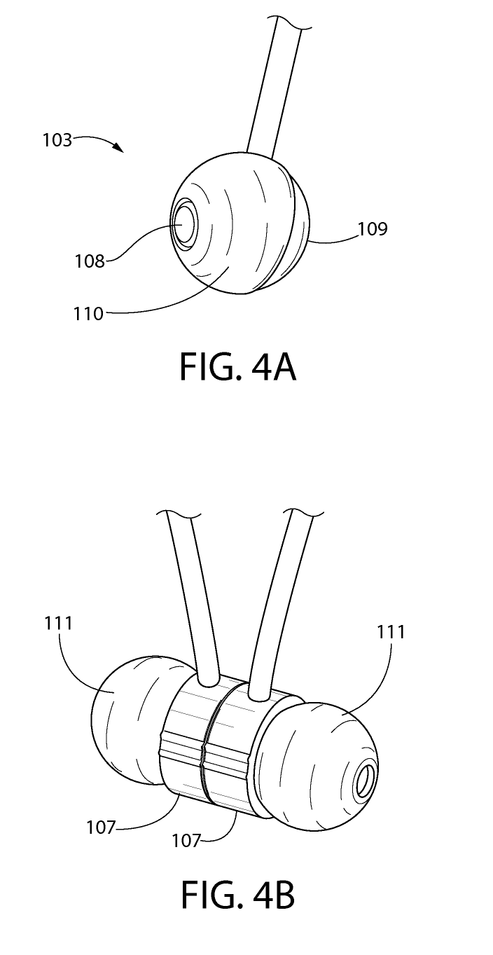

Referring now to FIGS. 3A through 3E, there are shown various views of the mother bead of the present invention. Each of the mother beads 102a, 102b, 102c, 102d, 102e is sized and shaped so as to resemble an ornamental bead that can be used as jewelry. For instance, the housing member of the mother beads may be disc shaped, triangular, rectangular, crescent-shaped, annular, or spherical. Each of the housing members comprises a defined interior volume for storing various electrical components therein. In one embodiment, the outer surface of the mother bead 102e comprises a button 106 thereon.

The button 106 may be dedicated to perform a single function when depressed or actuated. Alternatively, the button 106 may be dedicated to perform multiple functions. In such embodiment, each function may be associated with a specific tap, e.g., single tap or double tap, squeeze, e.g., single squeeze or double squeeze, or other types of physical contact. The button 106 may be coupled to one or more sensors and the processor embedded within the mother bead 102 for executing a set of instructions.

Alternatively, the mother bead 102f may be shaped so that it can be worn on the back of the neck of the wearer, as shown in FIG. 3F. In this regard, the mother bead 102f is slightly elongated and bent in shape to be ergonomic with the human body and follow the contours of the back of the neck. In this way, the mother bead 102f can be comfortably tucked under the collar of a shirt and/or worn under clothing. Additionally, the mother bead 102f allows the wearer to put on outer accessories such as a necktie or a scarf without creating a warping or bulging appearance. Preferably, the mother bead 102f centrally located along the wire sheathing 149 to balance the weight of the device. Additionally, other modular beads such as ear beads are weighted to prevent the mother bead 102f from sliding down the back of the wearer.

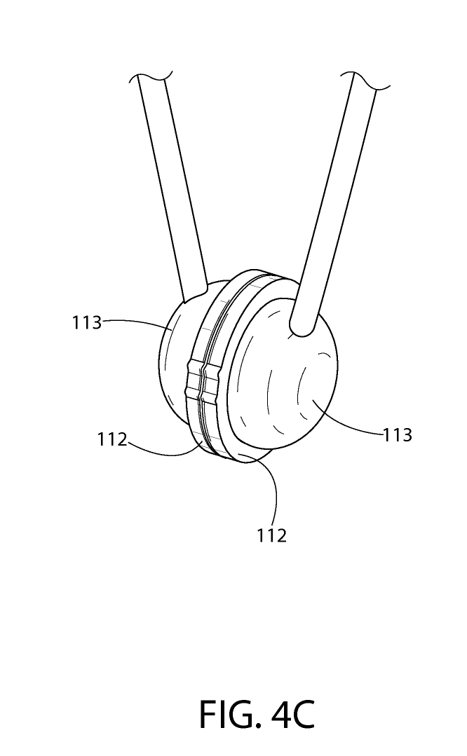

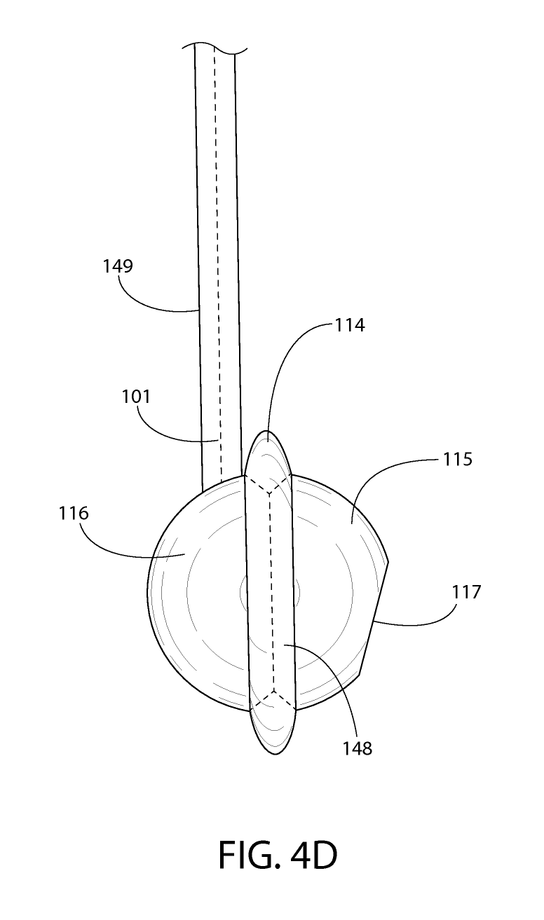

FIGS. 4A through 4D, there are shown various views of the ear beads 103. In one embodiment, the ear beads 103 are substantially spherical, as shown in FIG. 4A. The spherical embodiment comprises a first section 110 and a second section 109. The second section 109 is configured to face toward a wearer's ears and be partially inserted therein, and the first section 110 is configured to face outward and away from the wearer's ears. The second section 109 and the first section 110 may be composed of different materials. For example, it is contemplated that the second section 109 is composed of a softer material than the first section 110 so as to provide comfort to the wearer when worn.

The first section 110 comprises a button 108 or a dome-like switch thereon. The button 108 can be coupled to a pressure sensor or other types of sensors to detect when it is pressed or otherwise actuated. The button 108 may be dedicated to perform one or more functions, e.g., volume control, communicating with other modular beads or external devices, and/or inputting commands. In some embodiments, the button 108 may be utilized when the ear beads 103 are used as a hot bead or another modular bead. In one embodiment, both ear beads 103 may comprise a button 108 thereon, wherein each of the buttons 108 can be coupled to different functions. Alternatively, only one of the ear beads 103 may comprise a button 108.

Some embodiments of the ear beads may comprise magnets thereon, as shown in FIGS. 4B and 4C. FIG. 4B shows ear beads having a substantially spherical first section 111 that is attached to a second section 107, wherein the first section 111 is configured to be partially inserted into a wearer's ears and the second section 107 is connected to the terminal ends of the wire. The second section 107 is substantially disc-shaped and comprises magnets therein. The magnets in each of the second sections 107 allow the two ear beads to removably attach together when they are not worn.

Similarly, FIG. 4C shows ear beads having a substantially hemispherical first section 113 that is attached to a second section 112. In this embodiment, the first section 113 is connected to the terminal ends of the wire and the second section 112 is configured to be partially inserted into the wearer's ears. The second section 112 comprises magnets therein. Similar to the embodiment shown in FIG. 4B, the magnets in the ear beads allow them to clasp together when not being worn. In some embodiments, the magnetic attraction between the coiled wires of the speaker drivers of the ear beads can assist in the attraction of these elements. Typically, ear beads would repel one another because the orientation of the magnet coils is the same. In the present invention, the ear beads are antipodal beads so that they do not repel one another.

It is contemplated that the ear beads may comprise different sizes and shapes for comfortable fit in different ears. Additionally, the ear beads may contain an annular region of depression 148 around their circumference that allows for the insertion of silicon gaskets 114 of varying sizes to adapt to different ear dimensions, as shown in FIG. 4D. The gasket 114 is preferably located between a first section 115 and a second section 116 of an ear bead, wherein the first section 115 is configured to be partially inserted into the wearer's ear and the second section 116 is connected to the wire 101 that is enclosed in the wire sheathing 149. In the illustrated embodiment, the second section 116 is hemispherical in shape. The first section 115 comprises an edge 117 that defines a planar surface having speaker perforations. In this way, the first section 115 is a partial hemisphere.

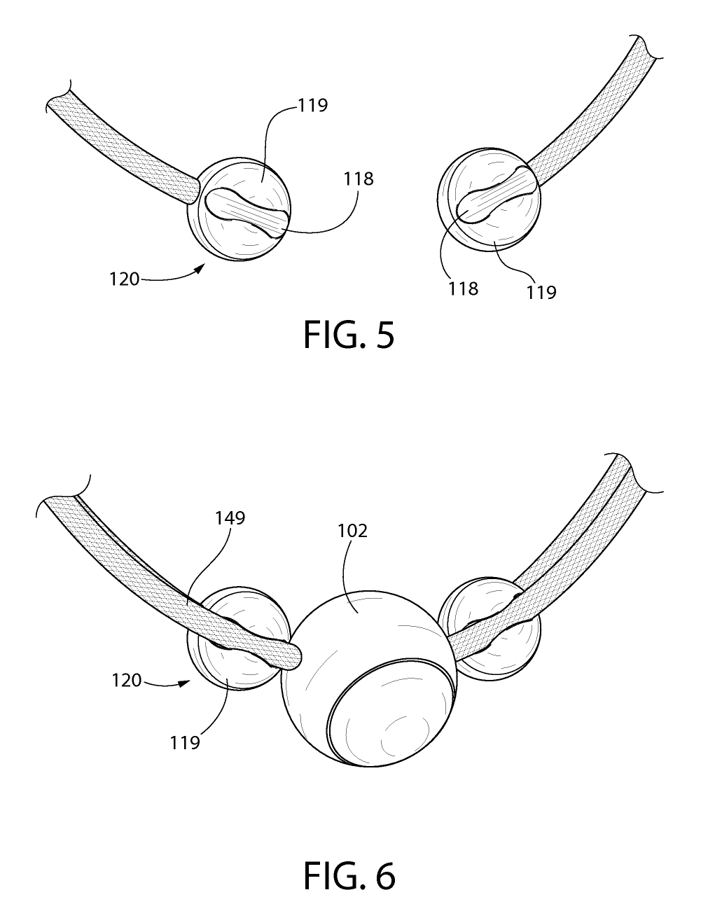

Referring now to FIGS. 5 and 6, there are shown alternate embodiments of the ear beads 120. The alternate embodiment of the ear beads 120 comprises an inner section 119 having a groove 118 for removably attaching to the wire sheathing 149. In this regard, the groove 118 is shaped and dimensioned to at least partially mate with the circumference of the cross section of the wire sheathing 149. In the illustrated embodiment, the groove 118 spans the substantial diameter of the ear bead. Additionally, the groove 118 slightly tapers at the substantial midpoint thereof so as to prevent the wire sheathing 149 from easily escaping therefrom.

The wire sheathing 149 snugly fits into the groove 118 so that the ear beads 120 remain in place adjacent to the mother bead 102 when they are not worn. However, the wire sheathing 149 can slide within the groove 118 so that the ear beads 120 can move closer to or further apart from the mother bead 102. Preferably, the speaker perforations on the ear beads 120 are located on the surface of the groove 118, leaving outer body of ear bead 120 free of perforation.

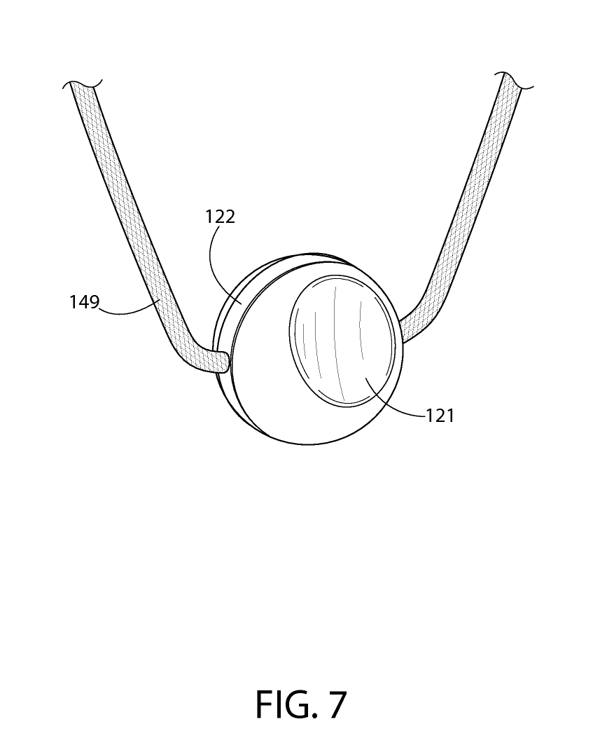

Referring now to FIG. 7, there is shown a view of a mother bead having a recessed capacitance trigger. The illustrated embodiment of the mother bead comprises a spherical housing member with a mid portion 122 for connecting to a portion of the wire sheathing 149. One side of the housing member comprises a recessed capacitance trigger 121 for reducing the risk of false positive readings. More specifically, the recessed capacitance trigger 121 comprises a predetermined threshold, which triggers events responsive to the wearer's digit or appendage via pressure, contact area, or proximity. In other embodiments, however, the mother bead may comprise other types of recessed buttons for reducing the risk of false positive readings.

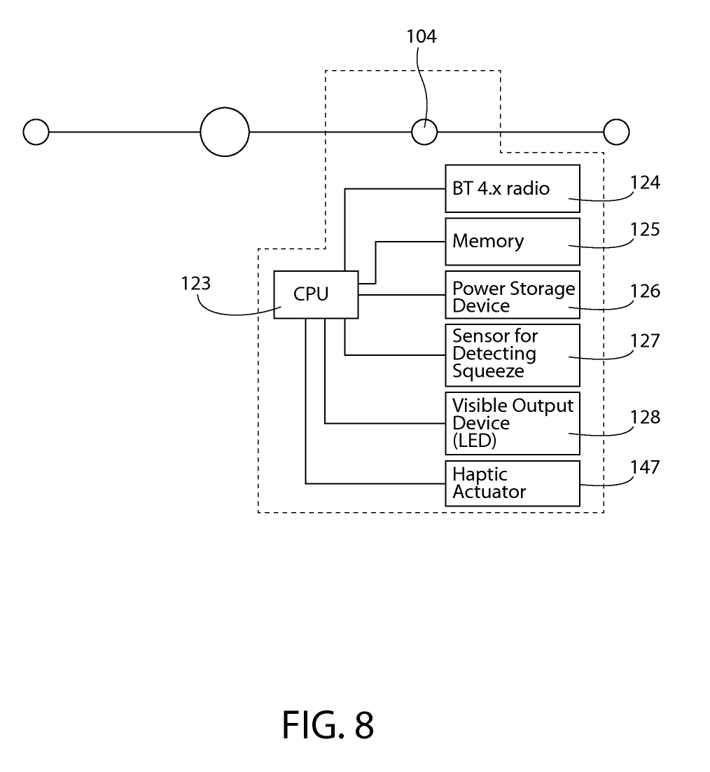

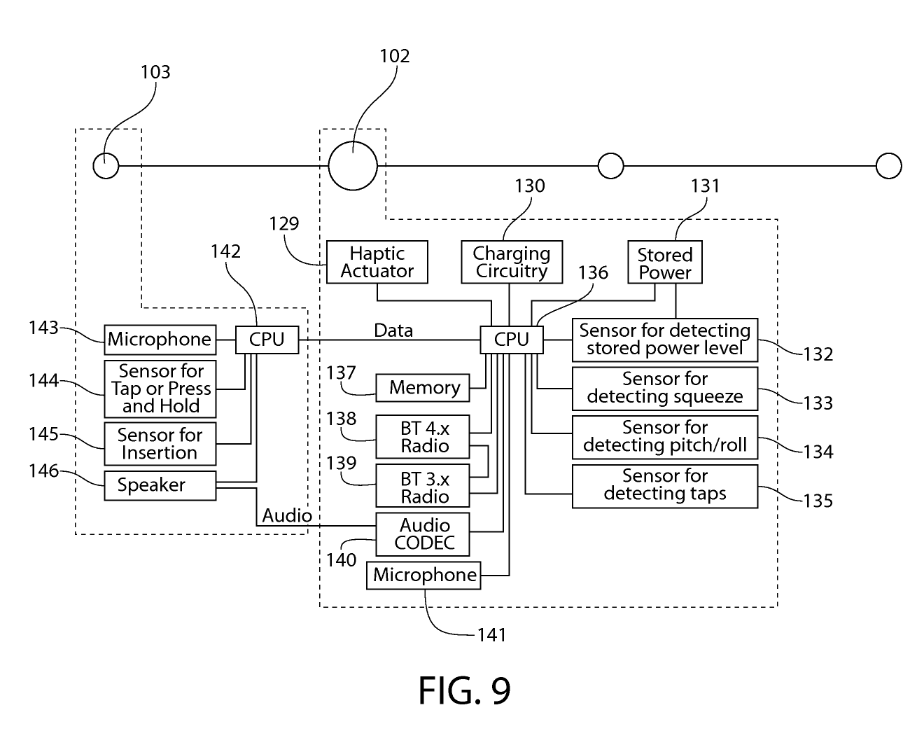

Referring now to FIGS. 8 and 9, there are shown block diagrams of exemplary embodiments of the present invention. Without limitation, the hot bead 104 comprises a processor, i.e., CPU 123 that is connected to a radio 124, a memory unit 125, a power storage device 126, a sensor for detecting squeeze 127 or another type of tactile sensor, a visible output device 128, and a haptic actuator 147. In some embodiments, the hot bead 104 may comprise any suitable processor known in the art other than the CPU 123 as shown in FIG. 8.

Additionally, the radio 124 of the hot bead 104 can be configured for any suitable wireless communication. In the illustrated embodiment, the radio 124 comprises a Bluetooth® version 4.x radio. In this manner, the hot bead 104 can wirelessly communicate with the radio, e.g., Bluetooth® version 4.x radio, of the mother bead. The memory unit 125 of the hot bead can be any suitable memory unit, including for example, the memory described herein with respect to the mother bead.

The power storage device 126 of the hot bead 104 can be any suitable power storage device, including, for example, the power storage component described herein with respect to the mother bead. In one embodiment, the power storage device 126 is a battery, such as a permanent “lifetime” battery, a rechargeable battery, or a replaceable battery. In still other embodiments, the power storage device 126 can be a conductively chargeable power source or an inductively chargeable power source, e.g., using radio-frequency identification architecture.

The sensor 127 is configured detect that the hot bead 104 has been squeezed. The sensor 127 can be any suitable tactile sensor described herein, including, for example, a sensor described with respect to squeeze detection of the mother bead. In one embodiment, the hot bead squeeze detection mechanism is a pressure sensor, such as a pressure sensor described with respect to the mother bead. In another embodiment, the squeeze detection mechanism includes a Boolean button, such as one that includes a membrane switch. Other suitable mechanisms for detecting that the hot bead 104 has been squeezed include mechanisms incorporating capacitive, conductive thermal, radiant thermal, and/or optical detection mechanisms, or any combinations thereof. When the sensor 127 detects that the hot bead 104 has been squeezed, the processor 123 determines the type of input to execute a set of instructions. For example, the hot bead 104 may be configured to call a first person directly when squeezed once; and call a second person when squeezed twice.

The visible output device 128 of the hot bead 104 can be, for example, a LED. The visible output device 128 can be configured to emit the visible output, i.e., light, in response to one or more predetermined events. For example, the visible output device 128 can emit light when the hot bead 104 is in electronic communication with the mother bead 102. In another example, the visible output device 128 of the hot bead 104 can emit light when a preselected person is calling. More specifically, the hot bead 104 can be associated with a device of the preselected person such that the hot bead 104 emits light when the processor 123 of the hot bead 104 detects that an electronic communication has been initiated to the hot bead 104 by the preselected persons' device.

Although the hot bead 104 has been illustrated and described herein as being configured for bi-directional communication using Bluetooth® connectivity, in other embodiments, other suitable mechanisms for bi-directional communication can be used. For example, in other embodiments, the hot bead 104 can be configured for bi-directional communication using inductive mechanisms, e.g., including a metallic housing or wires, conductive mechanisms, and/or infrared mechanisms, among other mechanisms.

The ear beads 103 comprises a processor, i.e., CPU 142 or any suitable processor that is operatively connected to a microphone 143, a sensor for detecting tap or press and hold 144, i.e., a pressure sensor, a sensor for detecting when it is inserted into the wearer's ears 145, and a speaker 146, wherein the speaker 146 may be coupled to the microphone 143. Both ear beads 103 may comprise the same set of components or a different set of components. The processor 142 of the ear bead 103 is configured to electronically communicate with a processor 136 of the mother bead 102, described in more detail herein. In this manner, the CPU 142 of the ear bead 103 can send data to and/or receive data from the processor 136 of the mother bead 102.

The sensor 145 is configured to detect when the ear bead 103 is worn in the wearer's ears. Information associated with the detected position of the ear beads 103 is transmitted to the CPU 142. The detection mechanism for determining that the ear beads 103 are inserted in the wearer's ears can be as a thermistor, a proximity sensor configured to detect a proximity of the ear bead 103 to the wearer's skin, a skin conductance sensor, an electrocardiogram (EKG) sensor, a capacitive sensor, a radiant thermal sensor, and/or an optical sensor.

Another suitable mechanism for detecting insertion of the ear bead into the wearer's ear includes monitoring the feedback of an electromagnetic frequency (EMF) load on the speaker 146 of the ear bead 103. For example, the EMF can be actively pulsed before the ear bead 103 is inserted into the wearer's ear. Speaker impedance is measured as the EMF is actively pulsed. The ear bud 103 can determine that it has been inserted into the wearer's ear when a threshold speaker impedance level is measured or otherwise detected.

Other suitable mechanisms for detecting insertion of the ear bead 103 in the wearer's ear include the use of one or more pressure sensors. For example, the ear bead 103 can include a switch that is mechanically deformed upon insertion of the ear bead 103 into the wearer's ear. In yet another example, the ear bead 103 can include an air or fluid pressure sensor that detects an increased pressure on a bladder of the sensor when the ear bead 103 is inserted into the wearer's ear.

Once the sensor 145 detects whether the ear bead 103 is inserted into the wearer's ear or not worn, the CPU 142 of the ear bead 103 decides whether to provide audio and/or tactile notifications. More specifically, if the ear beads 103 are not worn, the hot bead and/or the mother bead can vibrate or buzz to provide notifications because the wearer would be unlikely to hear sounds through the ear beads 103. If the ear beads 103 are worn, however, the ear beads 103 can output audio alerts.

The sensor 144 is configured to detect when the wearer taps an outer surface of the ear bead 103. Information associated with the detected tap is transmitted to the CPU 142. The tap detection mechanism can be a piezo touch plate, a capacitive sensor, a conductive thermal sensor, a radiant thermal sensor, an optical sensor, a feedback of the EMF load on the speaker 146, or any suitable combination of the foregoing. In this way, the ear beads 103 can also be used as input devices. For example, the wearer can double tap or single tap the ear bead 103 when it is in his or her ear to prompt an event.

Each of the ear beads 103 and the hot bead 104 is electronically coupled to the mother bead 102, e.g., via the wire or other electronic circuitry. In some embodiments, however, one or more of the ear beads 103 and the hot bead 104 can be wirelessly electronically coupled to the mother bead 102. In this regard, each modular bead, including the ear beads 103 and the hot bead 104, would have its own power source, e.g., battery, and short-range wireless interconnection capability so that it would act as a slave to the mother bead 102.

The mother bead 102 comprises a processor, i.e., CPU 136 that is connected to a haptic actuator 129, a charging circuitry 130, a power storage component 131, a sensor for detecting stored power level 132, a sensor for detecting squeeze 133, a sensor for detecting pitch/roll 134, a sensor for detecting taps 135, a memory unit 137, at least one radio 138, 139, e.g., a BT 4.x radio and a BT 3.x radio, an audio CODEC 140 (coder/decoder), and a microphone 141. The microphone 141 of the mother bead 102 transmits and receives audio with the speaker 146 of the ear beads 103.

Similar to the hot bead 104 and the ear beads 103, the mother bead 102 may comprise any suitable processing device configured to run and/or execute a set of instructions or code. For example, the processor can be a general-purpose processor, an accelerated processing unit (APU), or CPU as shown in FIG. 9. In some embodiments, the processor of the mother bead can be included in an application specific integrated circuit (ASIC). The processor can be configured to run and/or execute a set of instructions or code stored in the memory unit 137 associated with using a personal computer application, a mobile application, an internet web browser, telephonic or cellular communication, and/or the like. More specifically, in some instances, the processor 136 can execute a set of instructions or code stored in the memory unit 137 associated with: sending and/or receiving electronic communications, e.g., telephone or cellular calls, electronic messages, instant messages, video messages; and managing, navigating, sorting, accessing and otherwise operating a digital media library, virtual contact list, or other electronic files.

The memory unit 137 of the mother bead 102 can be, for example, a random access memory (RAM), a memory buffer, a hard drive, a read-only memory (ROM), an erasable programmable read-only memory (EPROM), and so forth. In some embodiments, the memory unit 137 of the mother bead 102 stores instructions to cause the processor to execute modules, processes, and/or functions associated with using a personal computer application, controlling one or more communication devices, managing, navigating, sorting, accessing and otherwise operating a digital media library, virtual contact list, or other electronic files, and the like.

The radio 138, 139 of the mother bead 102 can be configured for any suitable wireless communication. In FIG. 9, the radios comprise Bluetooth® versions 4.x or 3.x. The radio 138, 139 can be configured for wireless communication, i.e., sending and receiving wireless signals, with an electronic device and/or another modular bead external to and distinct from the mother bead. For example, the radio 138, 139 can be configured to wirelessly communicate with external electronic devices such as a mobile phone, a tablet, a personal computer, or the like. In another example, the radio 138, 139 can be configured to wirelessly communicate with another modular bead, such as the hot bead 104. In embodiments where the mother bead 102 includes at least two radios, such as the embodiment shown in FIG. 9, a first radio can be used to wirelessly communicate with an electronic device distinct from the present invention; and a second radio can be used to wirelessly communicate with one or more modular beads of the present invention.

The audio CODEC 140 is configured to encode and/or decode a digital audio data stream. Accordingly, the audio CODEC 140 is electrically coupled to each of the CPU 136 and at least one of the radios 138, 139 of the mother bead 102 and to the speaker 146 of at least one of the ear beads 103.

Each sensor 132, 133, 134, 135 of the mother bead 102 is electronically coupled to the CPU 136. The sensor 135 is configured to detect when the wearer taps an outer surface of the housing member of the mother bead 102. Information associated with the detected tap is transmitted to the CPU 136. The tap detection mechanism can be any suitable mechanism to detect a single, double, and/or triple, or more, tap by a wearer on the mother bead 102, or a press and hold on the mother bead, as described herein, including, for example, the tap and press-and-hold detection mechanisms described herein with respect to the ear bead 103.

In another example, the mother bead 102 includes a sensor 134 configured to detect movement or rotation of the mother bead 102. More specifically, the sensor 134 can be configured to detect that the mother bead 102 has been moved from a first position in which the mother bead 102 has a first pitch to a second position in which the mother bead 102 has a second pitch. As used herein, “pitch” refers to a degree of slant of an axis, such as a vertical axis, of the mother bead 102. Said another way, the pitch is a measure of a degree of rotation of the mother bead 102 around a side-to-side axis of the mother bead 102.

The sensor 134 can be configured to detect that the mother bead 102 has been rotated from a first position to a second position about a front-to-back axis of the mother bead 102, i.e., a roll of the mother bead 102. Information associated with the detected pitch and/or roll is transmitted to the CPU 136. In yet another example, the mother bead 102 includes a sensor 133 configured to detect when a wearer squeezes the mother bead 102. Information associated with the detected squeeze is transmitted to the CPU 136.

The mother bead 102 can be optionally configured to store power therein via the power storage component 131, e.g., a battery, coils, or the like. The power storage component 131 is coupled to the CPU 136. The power storage component 131 can optionally be coupled to the charging circuitry 130, for example, such that the power storage component 131 can be initially charged via the charging circuitry 130 by an external power source and/or recharged upon depletion of an amount of power from the power storage component 131. In some embodiments, the power storage component 131 is configured to be conductively and/or inductively charged via the charging circuitry 130.

In use, the stored power component 131 transmits electrical energy to the CPU 136 and other components of the mother bead 102. The mother bead 102 can optionally include a sensor 132 to detect the stored power level. The power level sensor 132 can be coupled to the stored power component 131 and/or to the CPU 135. Although the mother bead 102 has been illustrated and described as including the power storage component 131 therein, in other embodiments, the mother bead 102 can be operatively coupled to an external power storage component.

The mother bead 102 optionally includes a haptic actuator 129 or a motor that is configured to produce a vibration or other haptic feedback. The haptic actuator 129 is operatively coupled to the CPU 136. In use, the CPU 136 sends a signal to actuate the haptic actuator 129 to produce vibration, buzz, or other haptic feedback in response to predetermined events. For example, in use, the haptic actuator 129 produces a vibration in response to detection by one or more of the sensors of a pitch, roll, tap, squeeze, power level of the mother bead, or other predetermined events.

Thus, the vibration or other hepatic feedback produced by the haptic actuator 129 operates as an indication to the wearer of the one or more predetermined events. Although the mother bead 102 has been illustrated and described as including a single haptic actuator 129, in other embodiments, the mother bead 102 can include any suitable number of haptic actuators 129 or motors. The haptic actuator 129 can include any suitable mechanisms for producing haptic feedback, including, without limitation, pancake, linear resonant, eccentric rotating mass, piezo disk technology, or any suitable combinations thereof.

The mother bead 102 can include one or more additional or alternative mechanisms for detecting input or actuation of the mother bead by a wearer, including, for example, capacitance detectors, conductive thermal detectors, and radiant thermal detectors, or any combination of the foregoing detection mechanisms. The mother bead 102 utilizes these mechanisms to remotely interact with external electronic devices, such as a mobile phone.

There are a series of different UI options for this interaction:

Trigger:

Regardless of the UI direction, a trigger can be used to signal the mother bead 102 that it should be listening or anticipating a command. Using a trigger can prevent the wearer from inputting unintended commands. A trigger may operate in conjunction with various internal sensors, such as one or more sensors described herein. For example, the mother bead 102 may be triggered when the wearer holds it and not triggered when it is hanging loosely on the chain.

Virtual Track-Ball:

The mother bead 102 may operate similarly to a track-ball in a mouse. As the mother bead 102 is rotated, it scrolls through virtual indexes of information. For instance, for every 10 degrees of incremental rotation, different folder options can be accessed, e.g., music, contacts, main menu, etc. At each 10-degree index, the mother bead 102 is configured to vibrate or buzz via the haptic actuator. Additionally, the ear beads 103 can output sound at each 10-degree index as each folder option is accessed. In some embodiments, the mother bead 102 may comprise multiple vibrators that are calibrated such that different parts of the mother bead 102 can vibrate in a sequence as it is rotated.

In this way, the mother bead 102 replicates or imitates the sensation of a control knob when it is physical turned. Once the wearer accesses the folder, the wearer can tap the mother bead 102 to select the same. It is contemplated that an accelerometer can be used to detect the tap. The accelerometer may comprise a three-axis accelerometer, a six-axis accelerometer, or other types of accelerometers. The accelerometer may work in conjunction with a gyroscope.

Pressure:

Increasing or decreasing pressure on the mother bead 102 may allow the wearer to navigate through menu options. For example, the mother bead 102 can optionally include a piezo touch sensor such that a piezo disk of the sensor is exposed through or on the mother bead enclosure to be touched, in use, by the wearer.

Optical:

At least a portion of the exterior surface of the housing member of the mother bead 102 is sensitive to at least one of touch, light, and/or motion such that the mother bead can track input commands. For example, writing or drawing a letter on or proximate to an outer surface of the mother bead, e.g., with a wearer's finger, can be received by the mother bead as an input command to execute an action that is associated with the letter. Additionally, the wearer can swipe left or right to navigate through menu options, or swipe up or down to control volume.

It is contemplated that the present invention may further comprise other types of modular beads, depending upon embodiment. Without limitation, some embodiments of the present invention comprise a battery bead, one or more communication beads, a camera bead having a camera and an image processor, one or more visual output beads, and one or more health monitoring beads with sensors for measuring body metrics such as pulse, body temperature, and the like.

The battery bead comprises a power source such as a lithium ion battery or other suitable types of power source. Optionally, the battery bead further comprises a charging interface or a wiring scheme so that it can be rechargeable. The battery bead may be relatively large in the context of the scale of jewelry. Thus, it is contemplated that having multiple smaller battery beads might have ergonomic and aesthetic advantages over one large battery bead.

The communication beads comprise a short-range wireless interconnection bead, a collaboration beads, a lifeline bead, and the like. The housing member of the short-range wireless interconnection bead comprises a faraday cage. The faraday cage limits materials applicable for Bluetooth®. The short-range wireless interconnection bead can be optimally designed from a size and material perspective to transmit signal.

Each collaboration bead is preferably coupled with a specific function and can directly communicates with third party servers. In one embodiment, the collaboration bead may be configured to call a cab when it is activated. Similarly, The the lifeline bead is configured to dispatch first responders or law enforcement when it is activated. Additionally, the lifeline bead can transmit a preprogrammed message to prespecified recipients, wherein the message comprises the wearer's name, location, and health condition, if any.

The visual output beads comprise a display screen bead that is configured to provide visual output, such as light. The display screen may emit sufficient backlight to serve as a light source. Optionally, the visual output beads may further comprise a separate light source bead for providing further illumination. While the wearer may use the light source bead and the display screen bead to provide illumination, these beads primarily serve to notify others of the wearer's presence in low light environments.

In some embodiments, the modular beads can be included in two or more items of jewelry while being configured to operate as parts of a single system as a whole. For example, in one embodiment, a modular bead on a ring or bracelet is configured to operate as an input device for a wearer to access virtual libraries, and a necklace physically distinct from the ring or bracelet can include the ear bead 103 configured to audibly output the names of the folders or files accessed through the modular bead and the mother bead 102 configured to produce haptic feedback during the navigation of the virtual libraries using the modular bead. Said another way, in some embodiments, a set of modular beads can be physically discrete and wirelessly connected or paired together.

In another example, a wearer can wear a modular bead of the set on each of the wearer's wrist via a bracelet, ankle via an anklet, waist via a belt, head via a hair clip or tie, and neck via a necklace. The set of beads can be configured to detect and record body metrics and/or track a position of a portion of the wearer's body, e.g., relative to a different portion of the wearer's body, and such information can be collaborated and stored in a single bead, e.g., the mother bead 102. Also in this manner, such information can be collected from multiple points on the wearer's body substantially simultaneously by the set of linked beads.

A mother bead 102, or other modular bead, can be configured to electronically communicate with one or more external communication devices and perform methodologies discussed herein via application software. For example, the application can be resident on and/or loaded to an external communication device. Non-limiting examples of external communication devices include a personal computer, laptop, mobile phone, tablet, or the like.

The application may comprise a downloadable or a non-downloadable software, such as a web application, a website, a mobile application, or the like. The application enables the wearer communication device to establish communication, e.g., pair, with one or more modular beads, such as the mother bead 102 and/or another modular bead. The application provides a graphic user interface (GUI) for allowing the wearer to make selections, such as to preselect a caller for a specific hot bead, to preselect one or more persons for a specific hot bead, to set up notifications, e.g., push notifications, or the like.

In some embodiments, the application includes executable code for notification filtering. In this manner, the application and the modular beads can be characterized as collectively including a smart notification system. In some embodiments, the application enables user-directed filtering of notifications. More specifically, the application can allow a wearer to adjust filtering of notifications received by or pushed to the mother bead or other modular bead. In one embodiment, the application includes code to rank or otherwise categorize the user's contacts (or persons or other entity's in the user's social sphere, as stored in or recognized by the user communication device and/or a modular bead, such as the mother bead) into a default organizational arrangement or gradient system.

The application is also configured to allow the wearer to alter the default gradient system of the user's contacts based on the user's personal preferences. In use, the wearer can input into at least one of the user communication device or the modular bead a desired gradient of openness, for example, based on the user's mood or activity. Said another way, a wearer can indicate, via the application, a change to the level of its social sphere with whom the wearer is willing to communicate during a particular period in time in a day, for example in a range of from a very limited group of intimate contacts to everyone in the user's social sphere.

In this manner, the modular bead can be configured to receive notifications linked to the gradient system of the ranked user's contacts. For example, a wearer may be subscribed to one or more Really Simple Syndication (RSS) feeds, i.e., an electronic feed of news or other content sent to a subscriber device, often written in eXtensible Markup Language (XML) coding language. The modular bead is configured to permit the user to toggle their social sphere down to block the RSS feeds or a subset of the RSS feeds at a first period in time, and to toggle their social sphere up or open to allow the RSS feeds or a greater portion of the RSS feeds.

Said another way, the wearer can input a selection of level of openness using a modular bead such that the application in the user communication device can limit receipt of electronic communications by the user communication device and/or the modular bead(s) to those electronic communications that satisfy the selected level of openness. In some embodiments, the application is configured to permit the user to open and/or close communication channels, e.g., via the modular bead and/or the user communication device, based on predetermined subsets of the user's social sphere (or contacts), for example, such that the wearer can selectively open their personal social network sphere, but close their work network sphere, notifications sphere, or the like.

Some embodiments described herein relate to a computer storage product with a non-transitory computer-readable medium, also referred to as a non-transitory processor-readable medium, having instructions or computer code thereon for performing various computer-implemented operations. The computer-readable medium or processor-readable medium is non-transitory in the sense that it does not include transitory propagating signals per se, e.g., a propagating electromagnetic wave carrying information on a transmission medium such as space or a cable. The media and computer code may be those designed and constructed for the specific purpose or purposes.

Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as ASICs, Programmable Logic Devices (PLDs), ROM and RAM devices. Other embodiments described herein relate to a computer program product, which can include, for example, the instructions and/or computer code discussed herein.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A wireless headphone resembling a piece of jewelry, comprising:
at least one ear bead in communication with a mother bead, each of said at least one ear bead and said mother bead having a housing member, wherein said housing member comprises a jewelry-like outer appearance, further wherein said mother bead acts as a master and said at least one ear bead acts as a slave;
said ear bead comprising a speaker for outputting audible sound;
said mother bead comprising a first processor operatively connected to a first memory unit, a first set of output devices, and a first set of sensors configured to transmit information associated with detected input to said first processor of said mother bead, wherein said mother bead is in communication with a first set of external electronic devices to operate said first set of external electronic devices.

2. The wireless headphone of claim 1, further comprising:
a hot bead in communication with said mother bead, wherein said hot bead acts as a slave to said mother bead;
said hot bead comprising a housing member having said jewelry-like outer appearance, said housing member of said hot bead enclosing a second processor operatively connected to a second memory unit, a second set of output devices, and a second set of sensors configured to transmit information associated with detected input to said second processor of said hot bead, wherein said hot bead is coupled to a second set of external electronic devices to operate said second set of external electronic devices, further wherein said hot bead configured to act as a short cut to execute a specified functionality.

3. The wireless headphone of claim 1, wherein said at least one ear bead and said mother bead are physically connected via an elongated wire to resemble an open necklace that is configured to be draped at least once around a user's body.

4. The wireless headphone of claim 3, wherein said at least one ear bead comprises a groove that is configured to partially encircle said wire such that said at least one ear bead is secured adjacent to said mother bead.

5. The wireless headphone of claim 1, wherein said mother bead is shaped to be ergonomic with a human body so that said mother bead can be worn on the back of a human neck.

6. The wireless headphone of claim 1, wherein said at least one ear bead is magnetic, thereby allowing two or more of said at least one ear bead to removably attach together when not worn.

7. The wireless headphone of claim 1, wherein said at least one ear bead further comprises a microphone.

8. The wireless headphone of claim 1, wherein said at least one ear bead further comprises a third set of sensors;
said third set of sensors comprising a sensor that is configured to determine whether said at least one ear bead is inserted in a user's ear.

9. The wireless headphone of claim 8, wherein said mother bead is configured to provide notifications via vibrations when said sensor determines that said at least one ear bead is not inserted in said user's ear.

10. The wireless headphone of claim 1, wherein said mother bead further comprises a microphone.

11. The wireless headphone of claim 2, wherein said mother bead further comprises at least one radio;
said at least one radio of said mother bead configured to establish communication with said hot bead, said at least one ear bead, and external electronic devices.

12. The wireless headphone of claim 1, wherein said first set of output devices of said mother bead comprises a light emitting diode and at least one haptic actuator for providing vibrations.

13. The wireless headphone of claim 1, wherein said mother bead further comprises an audio CODEC that is operatively connected to said speaker of said at least one ear bead to transmit audio signals.

14. The wireless headphone of claim 1, wherein said mother bead comprises a recessed capacitance trigger for reducing false positive readings.

15. A wireless headphone resembling a piece of jewelry, comprising:
a first modular bead in communication with a second modular bead, each of said first modular bead and said second modular bead having a housing member, wherein said housing member comprises a jewelry-like outer appearance, further wherein said first modular bead and said second modular bead are physically connected via an elongated wire to resemble an open necklace that is configured to be draped at least once around a user's body;
said first modular bead comprising a first processor operatively connected to a first memory unit, a first set of output devices, and a first set of sensors configured to transmit information associated with detected input to said first processor of said first modular bead, wherein said first modular bead is in communication with external electronic devices to operate said external electronic devices;
said second modular bead comprising a speaker for outputting audible sound.

16. The wireless headphone of claim 15, wherein said first modular bead further comprises a microphone.

17. The wireless headphone of claim 15, wherein said second modular bead further comprises a microphone.

18. The wireless headphone of claim 15, wherein said first set of output devices of said first modular bead comprises a light emitting diode and at least one haptic actuator for providing vibrations.

19. The wireless headphone of claim 15, wherein said first modular bead further comprises at least one radio that is configured to establish communication with said second modular bead and said external electronic devices.

20. The wireless headphone of claim 15, wherein said second modular bead further comprises a second processor operatively connected to said speaker, said first processor of said first modular beads, a second set of sensors configured to transmit information associated with detected input to said second processor of said second modular bead.
